(19) United States
(12) Patent Application Publication
(10) Pub. No.: US 2009/0178368 A1
(43) Pub. Date: Jul. 16, 2009

(54) Apparatus and method for window jamb installation

(76) Inventor: Jeff Paddock, La Pine, OR (US)

Correspondence Address: HANCOCK HUGHEY LLP, P.O. BOX 1208, SISTERS, OR, 97759, US

(21) Appl. No.: 12/008,901

(22) Filed: Jan. 15, 2008

(51) Int. Cl. E04F 21/00; E06B 1/00

(52) U.S. Cl. 52/749.1; 52/745.15

(57) ABSTRACT

A guide bracket is attached to a screw gun that is used to drive screws into a window rough opening. The heads of the screws are used to define set offs to position a window jamb box in a desired position in the window opening relative to a window installed in the opening. The bracket is attached to the screw gun in any appropriate manner and includes a stop member that stops travel of the screw gun as it is being operated to drive the set off screws; the stop abuts a reference surface on the window frame to thereby fix the position of the jamb box when installed into the rough opening.

### FIELD OF THE INVENTION

This invention relates to an apparatus and method for quickly and reliably positioning and installing window jamb extensions, and more particularly, apparatus for aligning window jamb extensions using screws as set off points.

### BACKGROUND

Many newly constructed homes in the US use windows that have a relatively shallow frame compared to the thickness of the wall, and which as a result leave rough framing exposed after the window has been installed. Vinyl windows are a good example. To provide an attractive finish, the exposed framing material has to be covered with wood or another finish covering such as sheet rock. Vinyl windows are typically only a couple of inches deep; when the window is installed in the rough window opening there is a gap of several inches between the inside edge of the window and the inside surface of the interior wall. This gap must be covered by a finish carpenter so that the rough framing material—typically 2×6 fir—is not exposed. Sometimes the rough framing is covered with drywall. More typically, the finish carpenter builds and installs a window jamb extension, or “jamb box,” which covers the rough framing and provides an attractive finish. The interior edge of the jamb box extends to a desired position relative to the interior wall surface, and finish casing is installed around the jamb box to finish the project.

Installation of the jamb box tends to be a time-consuming process. First, a jamb box is built to appropriate dimensions for each window. The size of the jamb box will depend on several factors, such as the desire reveal, the type of window, etc. Once the jamb box is built, it must be installed in the window opening in the desired position. Conventionally, this is done by using wooden shims placed around the perimeter of the window opening between the jamb box and the rough frame. The shims function as stand offs that hold the jamb box at a desired position relative to the window, allowing the carpenter to set the jamb box in this position. Aligning a jamb box precisely with shims can be quite difficult, even for an experienced carpenter, since the shimming process requires some trial and error to get the reveals—that is, the relative positions between the jamb box and the window—right. Among other things, shims tend to be unequal in dimensions and multiple shims may need to be stacked to get the right set off. Moreover, it is important to use shims that are completely dry, because use of a wet shim can cause expansion and retraction of the shim after the jamb box is installed, and this can result in deformation of the jamb box. Once the position of the jamb box has been set with the shim stand offs, the box is nailed to the studs that define the rough opening.

There is a continuing need therefore for apparatus and method that make the job of correctly installing jamb boxes and other finish materials more accurate and economical. The present invention comprises apparatus that quickly and reliably places stand-offs around the perimeter of the rough framing so that a jamb box will be correctly aligned with the window when the jamb box is installed. The stand-offs are placed and adjusted by using the window itself as a reference point. Using the method facilitated by the apparatus, jamb box installation is much faster and much more accurate than the comparable process using shims.

### BRIEF DESCRIPTION OF THE DRAWINGS

The invention will be better understood and its numerous objects and advantages will be apparent by reference to the following detailed description of the invention when taken in conjunction with the following drawings.

FIG. 1 is a top plan, partially cross sectional view of a window installed in a rough window opening, and showing a cordless drywall screw gun fitted with a window jamb box stand-off positioning apparatus according to the present invention.

FIG. 2 is a cross sectional view of a window installed in a window opening and a jamb box installed in the rough opening and. 1, illustrating a method of anchoring the jamb box in place with a bead of adhesive between the jamb box and the trimmer board.

FIG. 3 is a close up view of a first illustrated embodiment of a jamb box stand-off positioning apparatus of the present invention installed on a drywall screw gun, only a portion of which is illustrated in phantom lines.

FIG. 4 is an elevational view illustrating a window installed in a rough window opening, and showing the relative positions and dimensions of the stand-offs installed according to the present invention.

FIG. 5 is a top plan, partially cross sectional view similar to the view of FIG. 1, illustrating of a window installed in a window opening, and showing a cordless screw gun fitted with an alternative embodiment of a window jamb box stand-off apparatus according to the present invention.

FIG. 6 is a partly schematic cross sectional view taken along the line 7-7 of FIG. 6, illustrating a single-stand off installed in a rough sill.

FIG. 7 is a view identical to the view of FIG. 7 but showing a window jamb box being inserted into the rough opening.

FIG. 8 is a perspective view of an alternative illustrated embodiment of a window jamb box stand-off positioning apparatus according to the present invention, mounted to a cordless drill.

FIG. 9 is a perspective view of the apparatus shown in FIG. 8, illustrating the components in an exploded view.

### DETAILED DESCRIPTION OF THE PREFERRED EMBODIMENTS

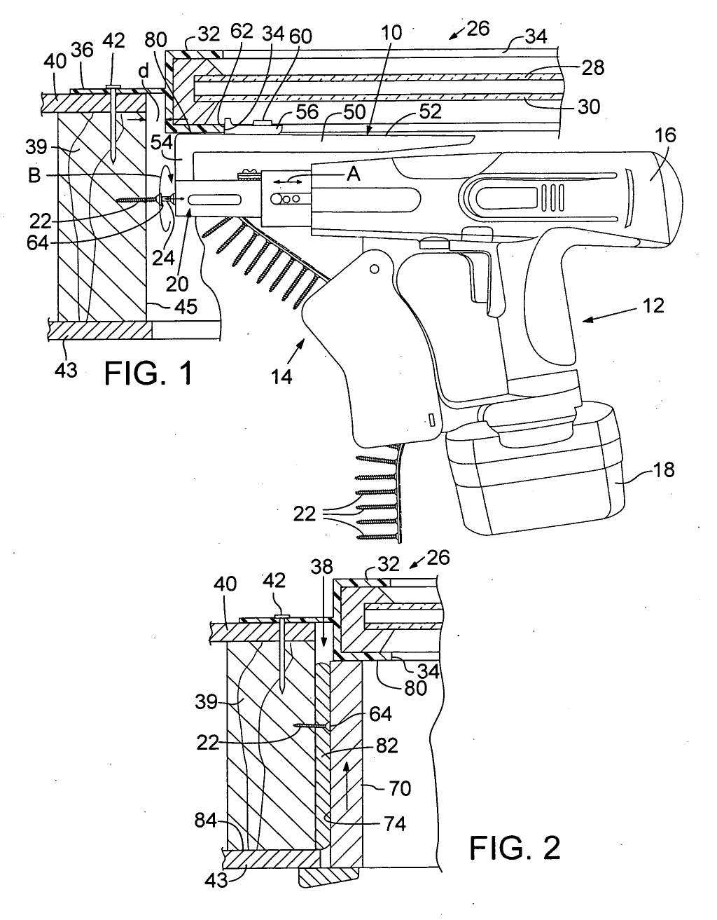

With reference to the drawings, several embodiments of a window jamb box stand-off apparatus 10 according to the present invention are illustrated as used with different types of cordless screw guns 12. In FIG. 1, apparatus 10 is adapted for use with a drywall screw gun 12 having an automated screw feed assembly 14. Drywall screw gun 12 and automated screw feed assembly 14 are conventional units. Briefly described, the screw gun 12 includes a main body 16 that houses the drill components (such as the motor, drive gears, etc.). A battery pack 18 is fitted to the main body 16. The chuck assembly 20 in the screw gun 12 reciprocates back and forth in the directions shown by arrow A when pressure is applied by the operator to drive a screw 22 with a bit 24 (the rotational direction of bit 24 is shown with arrow B in FIG. 1 to show the direction the bit 24 rotates to drive screw 22 into the underlying surface—that is, the wood that is used to frame in the rough opening. The structure and operation of screw gun 12 as just described is conventional.

FIG. 1 is a partial sectional view that shows a conventional vinyl double pane window 26 having an outer glass pane 28 and an inner glass pane 30 retained in a vinyl frame 32. As with almost all vinyl windows and other types of windows, the frame 32 has a peripheral edge 34 on the inner side of the window (“inner” in this case referring to the direction toward the “interior” of the house). Since FIG. 1 is a partial sectional view only one part of the peripheral edge 34 is shown. Nonetheless, it will be appreciated that the peripheral edge 34 extends completely around the window. Window 26 further includes a mounting flashing 36 that extends outwardly from frame 32, and which typically is integrally formed with frame 32. Window 26 is shown installed in a rough window opening, which is defined herein as the framed-in opening in a structure.

Typically the rough opening, identified here with reference number 38, is defined by a rectangular opening (or other shape conforming to the shape of the window) formed with opposed side walls that are typically 2×6 inch wooden trimmer studs 39, a header 76 (FIG. 4) which is also typically wooden, and a base or sill plate 41 (FIG. 4), again typically wood and usually a 2×6. The inner surfaces of the rough opening define a rough opening surface 45 that eventually will be covered with the jamb box. Sheeting 40 is installed over the exterior of the building wall and may be seen in FIG. 1. The interior of the building wall is typically covered with sheet rock 43 or some other finish material. Regardless of how rough opening 38 happens to be framed in (which can depend on local building codes, the style of construction, etc.), the peripheral dimensions of the rough opening are greater than the dimensions of window 26, but less than the dimension of mounting flashing 36. Thus, as may be seen in FIG. 1, when window 26 is inserted into rough opening 38, flashing 36 extends over the edges of the rough opening (around the entire perimeter of the rough opening). Window 26 is attached to the building with nails 42 driven through flashing 36 and into the studs, etc. that make up the rough opening. One nail 42 is shown in FIG. 1 but several nails are used around the periphery of the window. It will be appreciated that when window 26 is installed in rough opening 38 it may or may not be precisely centered in the rough opening. In other words, the distance d in FIG. 1, which is the distance between the outer edge of window frame 32 and stud 39, may be different on one side of the window from the corresponding distance on the opposite side of the window. And this distance may be different still at both the top of the window (i.e., between the outer edge of frame 32 and the window header), and at the bottom of the window (i.e., between the outer edge of frame 32 and the sill plate 41 of rough opening 38.

Having described the general construction of the window opening, attention is now turned to jamb box stand off apparatus 10. As shown in FIG. 1, apparatus 10 is defined by a member or bracket 50 that has a planar upper surface 52 that extends rearwardly along the upper edge of screw gun 12 and which serves as a guide member for setting stand-offs. The forward end of bracket 50 has a downwardly angled portion 54 that is at an angle of roughly 90 degrees relative to the plane defined by upper surface 52. Apparatus 10 is attached to screw gun 12 by any appropriate means, and in FIG. 1 is shown schematically as being permanently attached to chuck assembly 20 as by welding. Apparatus 10 may similarly be mounted to the chuck assembly with screws and the like.

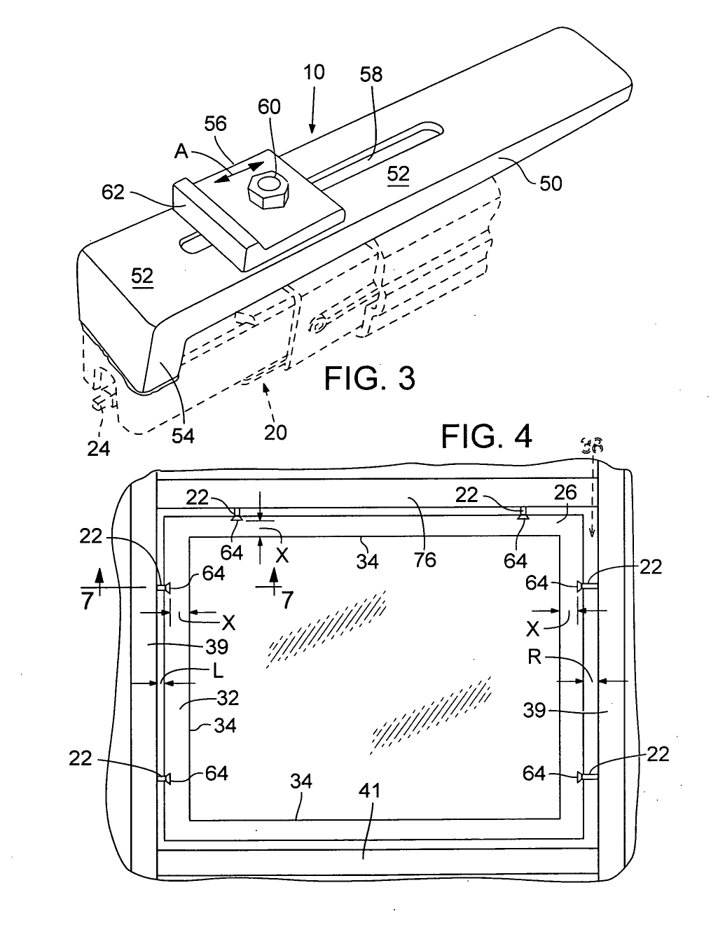

Turning to FIG. 3, apparatus 10 is shown in isolation with chuck assembly 20 shown in phantom lines. It may be seen that the bracket 50 is attached to chuck assembly 20 at the distal end of downwardly extending portion 54. As noted above, the bracket may be attached to chuck assembly 20 in any appropriate manner such as welding, screws, etc. Bracket 50 is attached to the chuck assembly at the forward edge of the chuck assembly, and nowhere else, so that the bracket does not interfere with the reciprocating movement of the chuck assembly, which as noted above is part of an automated screw feed system. A longitudinally adjustable stop 56 is attached to longitudinal slot 58 formed in upper surface 52 of bracket 50. Stop 56 may be moved to any selected position along the length of slot 56 by loosening nut 60 and sliding the stop in the slot 58 to the desired position, then retightening the nut. The longitudinal adjustability of stop 56 is illustrated with arrow A. It will be appreciated that there are many structures that are functionally equivalent to nut 60 and slot 58 for making the position of stop 56 longitudinally adjustable. As detailed below, the position of stop 56 and thus its forward edge 62 determines the depth to which screws 22 are set into the studs, header and sill that define rough opening 38.

The forward edge 62 of stop 56 defines a planar reference surface that is transverse to the longitudinal direction defined by longitudinal slot 58. The forward edge 62 defines a stop point. It is to be understood that as screw gun 12 is used to drive screws, the gun is moved back and forth in the directions shown by arrow A. Forward edge 62 is thus transverse to the longitudinal direction in which screw gun 12 normally is operated to drive screws into the wood (or other materials) that are used to define rough opening 38. As detailed below, forward edge 62 also defines a reference surface for setting the depth to which the stand offs are driven.

With returning reference to FIG. 1, it may be seen that screw 22 is a standard flat headed screw such as a drywall screw. The exposed surface 64 of screw 22 functions as a stand off point or surface for the jamb box, as detailed more succinctly below.

FIG. 2 illustrates a screw 22 driven into stud 39 and a jamb box 70 placed in the rough opening 38. Jamb box 70 is a rectangular wooden frame, the peripheral dimensions of which vary depending upon factors such as the desired reveal, the style of construction, etc. Importantly, in most instances the builder wants jamb box 70 to be precisely centered relative to the window 26. In other words, the dimension X (FIG. 4), which is the distance between the exterior edge 74 of jamb box 70 and the edge 34 of window frame 32 should be the same around the complete periphery of the installation. While the actual size of dimension X may vary according to a particular installation, it is usually desired and/or important that the dimension be the same all the way around the window. To accomplish this desired positioning, the position of stop 56 on bracket 50 of apparatus 10 is moved to a desired location. By fixing the longitudinal position of stop 56 in slot 58, the position of the forward edge 62 is fixed relative to the tip of drill bit 24. In other words, the distance between forward edge 62 and the tip of the drill bit 24 will be fixed once the stop is fixed in slot 58.

Determination of the position at which stop 56 will be fixed depends upon factors such as the desired reveal for the jamb box, etc., and adjustment of the stop to the desired position in slot 58 is the first step in the process of installing the set offs, which again are defined by the exposed surfaces 64 of screws 22. Next, plural screws are driven into studs 39, and also the header (shown in FIG. 4). For example, with reference to FIG. 4, two screws 22 are driven into each of the vertical and laterally opposed studs 39, and two screws 22 are driven into header 76. The screws 22 are placed at roughly even intervals along the length of the studs or header, although the distance between the screws and the number of screws used will vary with the size of the window opening. In most instances, screws 22 will not be driven into sill plate 41. As detailed below, this allows the installer to be able to position the jamb box more rapidly. However, screws 22 may optionally be driven into the sill plate 41. It will be appreciated that the combined exposed surfaces 64 of screws 22 along any single stud or header define a set off plane along which the outer edge of the jamb box will rest once the jamb box is installed.

As the screws 22 are driven into the rough opening surface defined by the studs and header, the portion of upper surface 52 of bracket 50 forward of forward edge 62 acts as a guide to assist with driving the screws as near perpendicularly into the studs as possible. That is, as shown in FIG. 1, upper surface 52 forward of stop 56 rests and rides upon the surface of the window frame 32 as the screw gun is operated to drive the screws.

FIG. 4 illustrates the situation where window 26 has not been precisely centered in rough opening 38, as mentioned above. Thus, the distance L, which is the distance between stud 39 and window frame 32 on the left side of the illustration is smaller than the corresponding distance R, which is the distance between stud 39 and window frame 32 on the right side of the illustration. Likewise, the distance from frame 32 to header 76 may not be the same as either L or R. Despite these differences caused by imprecise installation of window 26 in rough opening 38, the dimension X, which is the distance between inner peripheral edge 34 of window frame 32 and the upper surface 64 of screws 22 is the same at all points around the installation. This is due to the fact that the screws 22 are set into the studs and header such that the exposed surfaces of the screws rest at a uniform height relative to the peripheral edge of frame 32 because stop 56 stops the movement of screw gun 12 based on the window 26. Stated another way, the combined exposed surfaces 64 along any single stud define the stand off plane and that plane is located at a constant distance from the peripheral edge 34. Previously, dimension X was described as the distance between peripheral edge 34 and outer edge 74 of jamb box 70. Because jamb box 70 is positioned against the exposed surfaces 64 of screws 22, the dimension X may just as well be defined as the distance from edge 34 to the surface 64—the distance is the same.

Returning now to FIG. 1, the manner in which screws 22 are driven into the wood defining the rough opening is described. With screw gun 12 loaded with plural screws 22 in the automated feeding apparatus, screw gun 12 is positioned adjacent the inner pane 30 of window 26 such that when the screw gun is moved forward in the direction used to drive a screw (arrow A), the forward portion of upper surface 52 of bracket 50—that is, that portion of upper surface 52 forward of forward edge 62 of stop 56—rides on the surface 80 of window frame 32. As the screw gun is operated to drive screw 22 into stud 39 (arrow B), the screw gun moves toward the stud (arrow A) until forward edge 62 of stop 56 abuts peripheral edge 34 of frame 32, at which point the screw gun can be moved no further toward stud 39. Because the movement of screw gun 12 in the direction of arrow A (moving right to left in FIG. 1) is stopped when forward edge 62 hits peripheral edge 34, the screw 22 cannot be driven any further into stud 39. This sets the dimension X. Changing the position of stop 56 in slot 58 varies the actual length of dimension X.

With a sufficient number of screws 22 installed as just described around the periphery of the rough opening, jamb box 70 is installed into rough opening 38. This is done by inserting the jamb box such that the outer edge 74 of the jamb box abuts the exposed surfaces 64 of the screws 22. With reference to FIG. 2, the jamb box 70 is slid into rough opening 38 in the direction of arrow D. If no screws 22 have been driven into sill 41, then the lower edge of the jamb box will rest on the sill 41 when the box is installed. The opposed vertical edges 74 of the jamb box will abut the exposed surfaces 64 of screws 22—this effectively positions the jamb box. As described above, the combined exposed surfaces 64 define a stand off plane along each edge of the rough opening. When jamb box 70 is installed as shown in FIG. 2, the edges of the jamb box such as vertical edge 74 lies on the stand off plane.

Again assuming no screws 22 are driven into sill 41, once the jamb box is positioned in the rough opening, the installer lifts the jamb box upwardly with a pry bar or similar tool until the upper edge of the jamb box abuts the outer surfaces 64 of screws 22 that have been driven into header 76—that is, until the upper edge of the jamb box lies in the stand off plane defined by the set offs driven into the header. The jamb box is then fixed in place in a conventional manner, for example with finish nails driven through the jamb box and into the studs. In the event that screws 22 have been driven into sill 41, the jamb box is installed by inserting the box in the direction of arrow D. In either case, because dimension X is consistent around the entire periphery of window 26, the jamb box will be precisely oriented relative to the window.

Based on the foregoing description, it will be appreciated that forward edge 62 of stop 56 defines a reference point or dimension for setting the depth at which screw 22 may be driven into stud 39. In other words, by adjusting the position of stop 56 the position of the stand off defined by exposed surfaces 64 of screws 22 is fixed relative to the window frame 32.

FIG. 2 illustrates an optional method to attach jamb box 70 to the studs, header and sill that define rough opening 38. Specifically, after the set offs (i.e., screws 22) have been installed and the jamb box 70 has been installed as detailed above, a bead of adhesive 82 is applied between trimmer stud 39 and the jamb box 70, extending from roughly the point where the jamb box 70 meets window frame 32 to near the interior edge 84 of stud 39. The bead of adhesive 82 may be applied over a screw 22 or at any position along the rough opening. Preferably, plural beads 82 of adhesive will be applied as shown in FIG. 2 around the rough opening. The adhesive effectively secures the jamb box in place, either with traditional nails used to supplement the adhesive or without nails. The preferred adhesive for this application is an expandable construction adhesive such as the product sold under the brand name DOW ENERFOAM. Care must be taken to apply only so much adhesive that the jamb box is secured to the studs and header, avoiding over application of the adhesive. Over application of adhesive could result in the adhesive causing the jamb box to deform inwardly as the adhesive expands as it dries.

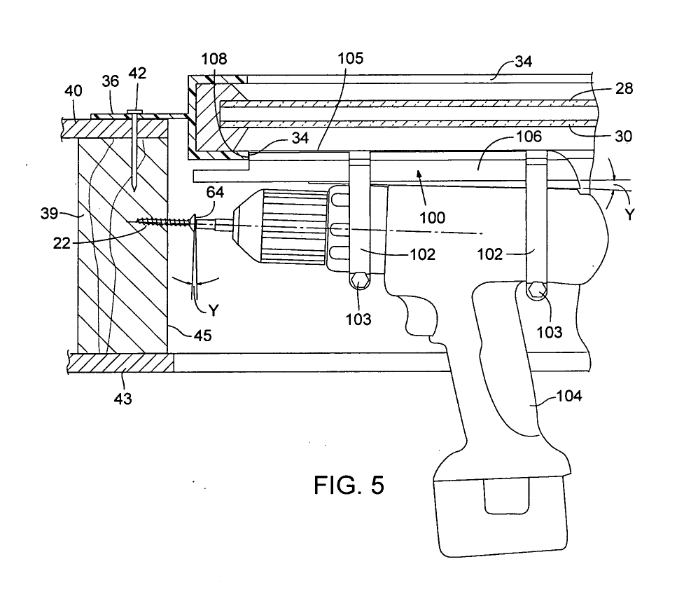

Reference is now made to the alternative embodiment of a window jamb box stand-off apparatus 100 illustrated in FIG. 5. Like structures in FIGS. 5 through 7 are given the same reference numbers as assigned earlier for FIGS. 1 through 4. In this case, the apparatus 100 is removably connected with bands 102 to a standard portable screw gun 104. Bands 102 include a nut 103 that is tightened to secure the bands and apparatus 100 to the screw gun. Apparatus 100 shown in FIG. 5 performs the identical function to apparatus 10 described above and includes an elongate body 106 that has an upper surface 105 that extends along the longitudinal directional axis of the screw gun, and a forward edge 108 that is analogous to forward edge 64 in the apparatus of FIG. 1. Specifically, forward edge 108 is formed as part of elongate body 106 and extends transverse to the longitudinal axis of the elongate body. The forward edge 108 serves as a stop that abuts peripheral edge 34 of window 26 when the screw gun is used to drive a screw 22 into, for example, stud 39. In the embodiment shown in FIG. 5, forward edge 108 is formed as an integral part of elongate body 106 and is therefore not separately adjustable in the position that it inhabits relative to the screw gun. Nonetheless, the position of forward edge 108 may be adjusted by moving the position of apparatus 100 on the screw gun. This is done by loosening nuts 103 and then moving elongate body 106 to the desired position, then retightening the nuts.

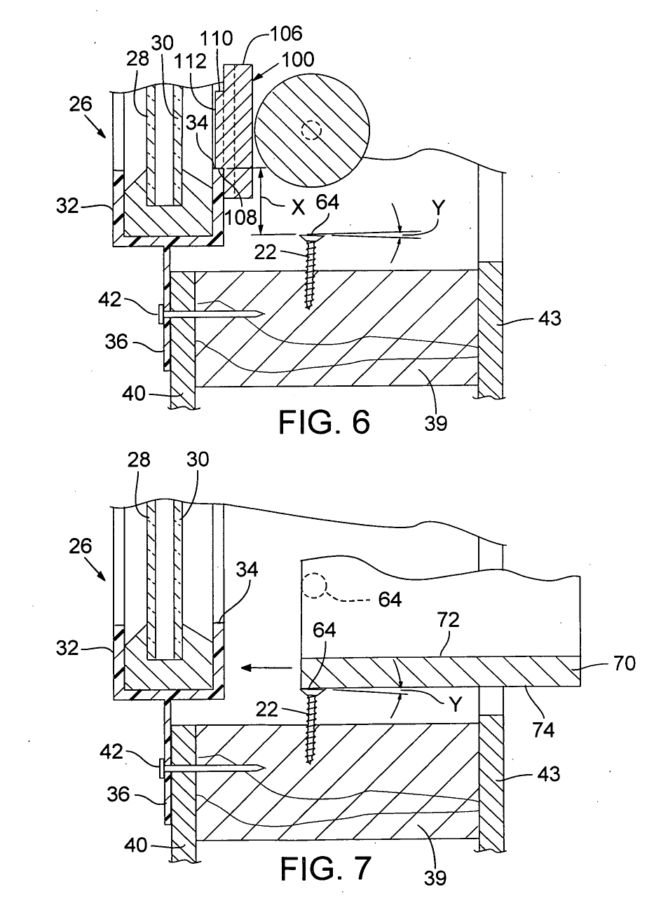

It will be appreciated that the angular orientation of the upper surface 105 relative to the plane defined by inner pane 30 of window 26 may vary depending upon the model of screw gun 104, the manner in which the apparatus 100 is attached to the screw gun, and other factors. This can result in the screw 22 being driven into stud 39 at an angle Y relative to the inner surface 45 of stud 39. Thus, preferably the screw 22 is driven into stud 39 such that the screw is perpendicular to surface 45. When this orientation is achieved, the exposed surface 64 of the screws 22 is parallel to the surface 45 of the stud. However, if screw 22 is driven into stud 39 at angle Y, then the exposed surface 64 of screw 22 is at a similar angle Y relative to the plane of surface 45. With reference to FIGS. 6 and 7, it may be seen that this angular orientation does not cause the jamb box to be installed incorrectly. Specifically, as best seen in FIGS. 6 and 7, the angular deflection of the screw does not impede the location or positioning of jamb box 70. Thus, even if one or more screws 22 are driven into stud 39 at an angle Y that is other than perpendicular to the surface 45 of the stud, the combined exposed surfaces 64 continue to define a stand off plane around the periphery of the rough opening.

Those of skill in the art will readily recognize that certain modifications to the apparatus and method described above may be made without departing from the invention defined herein. While the inventive apparatus and the methods employed to use it are described and embodied with respect to mounting jamb boxes in rough window openings, the invention is not limited in use to wooden jamb boxes or to windows. Instead, those of ordinary skill in the art will readily recognize that the apparatus described and claimed herein may be used to locate other finish materials such as sheet rock in rough openings, and in other construction endeavors.

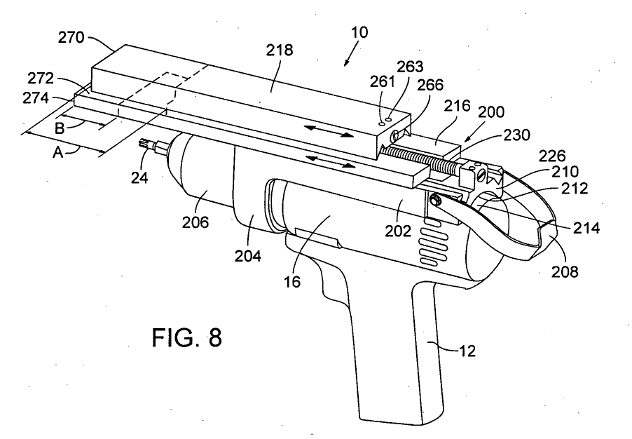

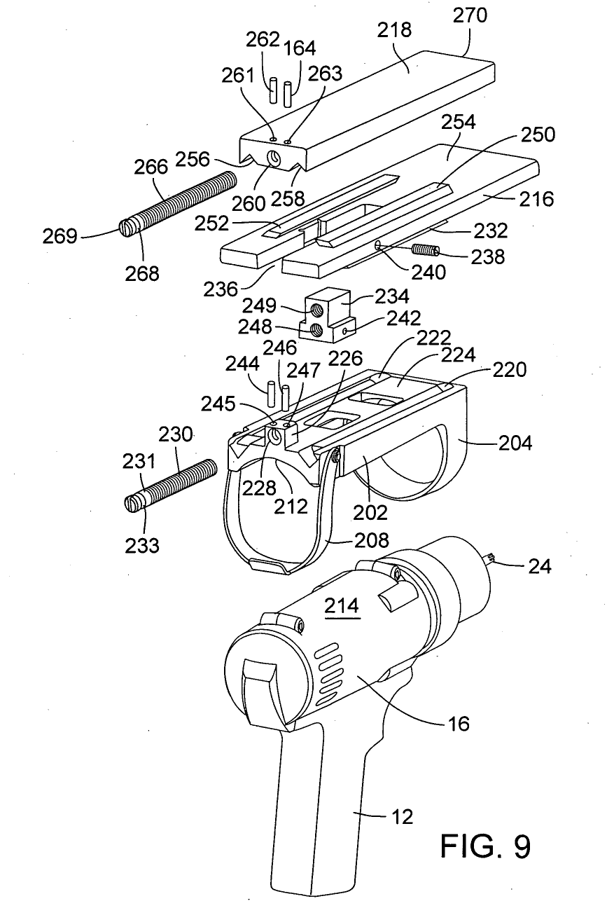

An alternative embodiment of the jamb box stand-off apparatus 10 according to the present invention is shown in FIGS. 8 and 9 and is identified generally with reference number 200. Apparatus 200 is defined by a base member 202 that quickly and universally mounts to drill 12. Base member 202 includes a forward ring 204 that is received around and encircles the forward end 206 of drill 12, and a clip 208 that is pivotally attached to the rearward end 210 of the base member. It will be appreciated from FIG. 8 that the inner surface 212 of base 202 is longitudinally concave so that the base rests upon the longitudinally curved and convex upper surface 214 of drill 12. With the apparatus 200 fitted over drill 12 as shown in FIG. 8, clip 208 may be used to quickly attach and detach the apparatus from the drill. Optionally, clip 208 may be provided with a tightening mechanism in order to more securely attach the clip, and thus the entire apparatus 200, to the drill.

A first plate 216 is mounted to base member 202 such that the first plate is longitudinally adjustable relative to the base, and second plate member 218 is mounted to first plate 216 such that the second plate is longitudinally adjustable relative to the first plate. With reference to FIG. 9, base member 202 includes a pair of longitudinal grooves 220 and 222 that extend along the length of the upper surface 224 of the base. A bolt stop 226 is mounted at the rearward end of the base 202. Bolt stop 226 has an opening 228 extending therethrough for receiving bolt 230.

First plate 216 includes opposed longitudinally extending and downwardly depending rails 232 (only one of which is illustrated in the perspective view of FIG. 9), which are received in grooves 220 and 222, respectively, when the first plate 216 is mounted to the base member 202. A block 234 fits into a slot 236 in first plate 216 and is secured to the first plate with a set screw 238, which threads through an opening 240 in the first plate and into a threaded opening 242 in the block. With block 234 attached to base 202 with set screw 238, bolt 230 is inserted into opening 228 of bolt stop 226 and is threaded into a first threaded opening 248 in block 234. The rearward end 231 of bolt 230 includes an annular groove 233. When the bolt has been inserted into stop 226, first and second pins 244 and 246 are inserted into openings 245 and 247 in stop 226—the distance between openings 245 and 247 is less than the diameter of the opening 228. The pins 244 and 246 are received in the annular groove 233 to thereby fix the bolt 230 relative to stop 226.

First plate 216 further includes a pair of longitudinally extending rails 250 and 252 that extend from the upper surface 254 of the plate. Rails 250 and 252 are received into grooves 256 and 258, respectively, formed in the facing surface of second plate 218. Second plate 218 has an opening 260 with pin openings 261 and 263 for receiving pins 262 and 264, respectively. A bolt 266 that is identical to bolt 230 and which includes an annular groove 268 is inserted into opening 260 and threaded into a second threaded opening 249 in block 234. The rearward end 269 of bolt 266 is fixed relative to the second plate 218 with pins 262 and 264, which are received into the annular groove 268 as detailed previously with respect to bolt 230.

With returning reference now to FIG. 8, it is readily apparent that the combination of first and second plates 216 and 218 allow for easily variable adjustment of the apparatus 200. Specifically, forward edge 270 of second plate 218 defines a planar reference surface that is transverse to the longitudinal axis of the plates—forward edge 270 defines a stop point and is directly analogous in structure and function to forward edge 62 described above. The upper surface 272 of first plate 216 is likewise structurally and functionally analogous to upper surface 52 of bracket 50 described previously. First plate 216 is longitudinally movable relative to base 202 by rotation of bolt 230. As bolt 230 is rotated, end 231 remains fixed relative to base 202 and bolt stop 234 is moved as the bolt threads into, and out of opening 248. Since bolt stop 234 is fixed relative to first plate 216, the first plate slides longitudinally relative to the base 202 as the bolt 230 is rotated. Likewise, and in the same manner, second plate 218 is longitudinally movable relative to first plate 216 by rotation of bolt 266. The combination of first and second plates 216 and 218 being movable relative to one another (illustrated by the double-ended arrows in FIG. 8), and first plate 216 being movable relative to base 202 allows for significant adjustability in the position of the stop point defined by forward edge 270, as illustrated by dimension A in FIG. 8, and in the position of the forward edge 274 of first plate 218 relative to bit 24 of drill 12.

As best seen in FIG. 8, second plate 218 is narrower than first plate 216 so that there is a step 280 defined between the two plates. In operation, the step 280 may be used as a guide surface that may be used to slide along the edges 34 of the frame 32 of a window as stand-off screws 22 are installed.

It will be understood that the infinitely relative variable adjustability between the first and second plates described above may be varied by adapting apparatus 200 with preset positions for the two plates relative to one another.

As yet another example, it is possible to mount the stand off apparatus 10 on either side of the screw gun rather than along the “top” or upper edge of the screw gun as illustrated herein. Furthermore, the apparatus 10 may be used with most any kind of drill or screw gun, whether battery operated or powered with standard electrical energy.

While the present invention has been described in terms of a preferred embodiment, it will be appreciated by one of ordinary skill that the spirit and scope of the invention is not limited to those embodiments, but extend to the various modifications and equivalents as defined in the appended claims.

I claim:

1. Apparatus for installing set offs for positioning a window jamb box for a window installed in a rough opening, said window having a window frame reference surface extending around the periphery of the window, comprising:
a member attachable to a screw gun, said member having a stop located in a position such that the stop is configured to abut the reference surface when the screw gun is operated.

2. Apparatus according to claim 1 wherein the screw gun has a longitudinal axis extending in the direction that a screw is driven by the screw gun, and wherein the member includes a guide surface extending parallel to the longitudinal axis and the stop is transverse to the longitudinal axis.

3. Apparatus according to claim 2 wherein the guide surface is a generally planar surface.

4. Apparatus according to claim 1 wherein the screw gun has a bit with a tip and the distance between the tip and the stop is adjustable.

5. Apparatus according to claim 1 wherein the bracket is removably attachable to the screw gun.

6. A method of installing set offs for locating a window jamb box in a rough opening in which a window has been installed, the rough opening defined by a peripheral rough opening surface and the set offs defined by screws, each screw having a screw head with an exposed surface, comprising the steps of:
a) driving multiple screws into the rough opening surface, and
b) setting the depth that the screws are driven into the rough opening surface based on a desired distance measured from a reference surface on the window to the exposed surface of the screw head.

7. The method according claim 6 including the step of installing a jamb box into the rough opening in a desired position relative to the window by inserting the jamb box into the rough opening such that the outer surfaces of the jamb box abut the exposed surfaces of the screw heads.

8. The method according to claim 7 wherein the screws are driven into the rough opening surface with a screw gun fitted with a stop, wherein the screws are driven into the rough opening surface until the stop abuts a reference surface on the window.

9. The method according to claim 8 including the step of gluing the jamb box to the rough opening surface.

10. The method according to claim 9 including the step of nailing the jamb box to the rough opening surface.

11. The method according to claim 6 wherein the combined exposed surfaces of plural screw heads define a stand off plane along which the outer surfaces of a jamb box will rest when the jamb box is installed in the rough opening.

12. A method of installing a window jamb box for a window installed in a rough opening, the jamb box having outer surfaces, comprising the steps of:
a) mounting on a screw gun a guide bracket having a stop surface;
b) adjusting the position of the stop surface so that when a screw is driven into a surface in the window rough opening the depth that the screw may be driven into the surface is limited by stop surface contacting a reference surface on the window; and
c) driving plural screws into the surface around the perimeter of the rough opening; and
d) installing the window jamb box in the rough opening such that the outer surfaces of the jamb box contact the screw heads.

13. The method of claim 12 including the step of gluing the jamb box to the rough opening surface.

14. The method according to claim 12 in which the rough opening defines a rectangle having opposed sides, a header and a sill, and wherein screws are driven into the sides and header.

15. The method according to claim 14 in which no screws are driven into the sill.

16. The method according to claim 15 including the step of raising the jamb box until the outer surfaces of the jamb box contact the screw heads at the header and then nailing the jamb box to the rough opening to fix its position relative to the window.

17. Apparatus adapted for attachment to a screw gun, comprising screw gun stop means for limiting the travel of the screw gun as it is operated when the stop means contacts a reference surface.

18. The apparatus according to claim 17 wherein the screw gun defines a longitudinal axis and the screw gun stop means further comprises a stop surface that is adjustable along the longitudinal axis.

19. The apparatus according to claim 18 wherein the screw gun further includes a bit having a tip, and wherein adjustment of the stop surface along the longitudinal axis changes the distance between the stop surface and the tip.

20. The apparatus according to claim 18 wherein the screw gun stop means further comprises a guide surface that extends along the longitudinal axis.
